(19) United States
(12) Patent Application Publication
(10) Pub. No.: US 2016/0087484 A1
(43) Pub. Date: Mar. 24, 2016

(54) WIRELESS CHARGING APPARATUS

(71) Applicant: Samsung Electronics Co., Ltd., Gyeonggi-do (KR)

(72) Inventor: Joon-Il KIM, Seoul (KR)

(21) Appl. No.: 14/862,378

(22) Filed: Sep. 23, 2015

(30) Foreign Application Priority Data
Sep. 23, 2014 (KR) 10-2014-0126989

(51) Int. Cl. H02J 7/02

(52) U.S. Cl. CPC H02J 7/025

(57) ABSTRACT

A wireless charging apparatus according to various embodiments of the present disclosure may include a wireless power transmitter that is included in a charging pad where an electronic device is placed, and may include a light source unit that provides light to a solar cell module included in the electronic device, wherein the light source unit may include a plurality of light sources that emit light outside the charging pad, and a plurality of sensors that are disposed between the light sources and close to the light sources and sense the electronic device.

### CLAIM OF PRIORITY

This application claims the priority under 35 U.S.C. §119(a) to Korean Application Serial No. 10-2014-0126989, which was filed in the Korean Intellectual Property Office on Sep. 23, 2014, the entire contents of which are hereby incorporated by reference.

### BACKGROUND

1. Technical Field

The present disclosure generally relates to a wireless charging apparatus, and more particularly, to a wireless charging apparatus that readily disperses heat generated during wireless charging.

2. Description of the Related Art

Electronic devices may include a battery for supplying power to the electronic device. Various methods for charging the battery may be used. Recently, an apparatus for charging a battery through wireless charging (or contactless charging) have been proposed. Wireless charging (or contactless charging) technologies are utilized for charging a battery of an electronic device that uses a rechargeable battery. The wireless charging technologies may use wireless power transmission and reception. For example, without connection of a separate charging connector between a charger and an electronic device, an electronic device may be automatically charged by just putting the electronic device on a charging pad.

As described above, a wireless charging apparatus may include a wireless power transmitter and a wireless power receiver for wireless charging. The wireless power transmitter wirelessly transmits power using a power transmitting member, and the wireless power receiver wirelessly receives power transmitted from the wireless power transmitter using a power receiving member. The power receiver may be included in a back side cover (or a back side case) mounted on the back side of the electronic device or the electronic device. In addition, the wireless power transmitter may be included in a charging pad where the electronic device is to be placed. When the electronic device is placed on the charging pad and the back side of the electronic device is in contact with the charging pad including the wireless power transmitter, the electronic device may receive power wirelessly transmitted from the charging pad and execute charging.

### SUMMARY

A wireless power transmitter and a wireless power receiver for charging a battery of an electronic device may be included in an electronic device and a charging pad, respectively.

A method for charging a battery of an electronic device may include an electromagnetic inductive charging method that transfers power through the current of primary and secondary coils, generated by induced electromotive force, resonant magnetic coupling that transfers power through Electro Magnetic Coupling (EMC) effect, radiated emission that radiates power for transferring power, or an energy harvesting method that uses wasted energy for example, vibration, heat, light, or the like, for charging.

However, the electromagnetic inductive charging method provides higher power transfer efficiency compared to other wireless charging methods, but requires high manufacturing costs since a low degree of freedom in charging or expensive components are used. In addition, an eddy current generated from the electromagnetic inductive charging method causes high heat, and a highly conductive conductor is required to obtain high efficiency between a wireless power transmitter and a wireless power receiver and thus, the manufacturing costs are high and RF noise may be generated.

In addition, wireless charging through the resonant magnetic coupling method provides a high degree of the freedom in location for charging, compared to the above described electromagnetic inductive charging method, but a highly conductive conductor needs to be used to obtain high charging efficiency and thus, manufacturing costs may increase. To broaden the charging distance, a large resonator may need to be installed based on the distance.

In addition, wireless charging through the radiated emission method may have significantly lower charging efficiency, compared to the above described two methods, and generates high-power radiation and makes noise.

In addition, the wireless charging through the energy harvesting method may provide significantly low charging power.

Therefore, various embodiments of the present disclosure provide a wireless charging apparatus that may execute wireless charging using solar light (solar cell) or light of a predetermined wavelength, for example, LED, artificial light, or the like.

In addition, various embodiments of the present disclosure provide a wireless charging apparatus that may execute wireless charging using a light source of a predetermined wavelength or converting a light source.

In addition, various embodiments of the present disclosure provide a wireless charging apparatus that only supplies power to the place where the electronic device is placed when the electronic device is laid on a charging pad for charging a battery.

According to one of the various embodiments of the present disclosure, a wireless charging apparatus includes a wireless power transmitter that is included in a charging pad where an electronic device is placed, and includes a light source unit that provides light to a solar cell module included in the electronic device, wherein the light source unit includes: a plurality of light sources that emit light outside the charging pad; and a plurality of sensors that are disposed between the light sources and close to the light sources, and sense the electronic device.

According to one of the various embodiments of the present disclosure, a wireless charging apparatus includes a wireless power receiver including a solar cell module provided in an electronic device, a wireless power transmitter included in a charging pad where the electronic device is placed, and that includes sensors that sense contact of the electronic device, and a plurality of light sources that provide light to the solar cell module based on whether the sensors sense contact, and a controller that controls light emission of the light sources, based on whether the sensors sense contact, wherein the controller controls light sources to emit light, which are located toward the inside from the outermost sensors from among the sensors that sense the contact of the electronic device, and the emitted light is converted into electric power through the solar cell module and contactless charging is executed.

A wireless charging apparatus according to various embodiments of the present disclosure may use, as a charging source, a light source that emits light of a predetermined wavelength in a charging pad, and includes, in an electronic device, a solar cell module that converts a light source into electricity, and thus, a light source may be converted into electricity and may be used for charging and used as power.

In addition, the light conversion efficiency of a light source generated from a predetermined light source included in a charging pad is approximately 150%, and a power conversion efficiency of a solar cell member of an electronic device that converts the light source into power is approximately 35% and thus, at least 50% of the light sources emitted from the charging pad of the present disclosure may be converted into charging power. Therefore, the method may have higher charging power than charging power of the conventional energy harvesting method.

In addition, a wireless charging apparatus according to various embodiments of the present disclosure enables only the light sources disposed in a location where an electronic device is placed to emit light, from among light sources included in a charging pad and thus, a waste of power may be prevented in an area that is not associated with charging of the electronic device and the dispersion of light sources emitted in association with the location of the electronic device may be prevented.

In addition, a wireless charging apparatus according to various embodiments may use light sources of a predetermined wavelength and a solar cell module and thus, may be free of RF noise, and may generate electricity harmless to humans and use the same for charging a battery, and may secure a degree of freedom in a location for charging or the like.

These and other features of the present disclosure will be more fully described hereinbelow with reference to the accompanying drawings.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view of a wireless charging apparatus shown relative to an electronic device according to one of the embodiments of the present disclosure;

FIG. 2 is a block diagram illustrating an operation of a wireless power receiver in a wireless charging apparatus according to one of the embodiments of the present disclosure;

FIG. 3 is a schematic plan view of an electronic device placed on a charging pad, in a wireless charging apparatus according to one of the various embodiments of the present disclosure;

FIG. 4 is a sectional view of an electronic device placed on a charging pad, in a wireless charging apparatus according to one of the various embodiments of the present disclosure;

FIG. 5 is a block diagram illustrating an operation of a wireless power transmitter in a wireless charging apparatus according to one of the various embodiments of the present disclosure;

FIG. 6 is a perspective view of a heat dissipation plate layered on a wireless power transmitter, in a wireless charging apparatus according to one of the various embodiments of the present disclosure;

FIG. 7 is a perspective view of an electronic device shown relative to a charging pad equipped with a heat dissipation plate of a wireless charging apparatus according to one of the various embodiments of the present disclosure;

FIG. 8 is a sectional view of an electronic device placed on a charging pad, in a wireless charging apparatus according to one of the various embodiments of the present disclosure;

FIG. 9 is a perspective view of another heat dissipation plate layered on a wireless power transmitter, in a wireless charging apparatus according to one of the various embodiments of the present disclosure;

FIG. 10 is a perspective view of an electronic device shown relative to a charging pad equipped with a heat dissipation plate, in a wireless charging apparatus according to an embodiment of the present disclosure;

FIG. 11 is a sectional view of an electronic device placed on a charging pad of a wireless charging apparatus according to an embodiment of the present disclosure; and

FIG. 12 is a flowchart illustrating an operation of a wireless charging apparatus according to one of the various embodiments of the present disclosure.

### DETAILED DESCRIPTION

Various embodiments of the present disclosure will now be described more fully in conjunction with the accompanying drawings. The present disclosure may have various embodiments, and modifications and changes may be made therein. Therefore, the present disclosure will be described in detail with reference to particular embodiments shown in the accompanying drawings. However, it should be understood that there is no intent to limit various embodiments of the present disclosure to the particular embodiments disclosed, but the present disclosure should be construed to cover all modifications, equivalents, and alternatives falling within the spirit and scope of the various embodiments of disclosure. In the description of the drawings, identical or similar reference numerals are used to designate identical or similar elements.

Hereinafter, the terms “include” or “may include”, which may be used in various embodiments of the present disclosure, refer to the presence of disclosed functions, operations or elements, and do not restrict the addition of one or more functions, operations or elements. Further, as used in various embodiments of the present disclosure, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” in various embodiments of the disclosure means the inclusion of at least one or all of the disclosed elements. For example, the expression “A or B” may include A, may include B, or may include both A and B.

The expressions such as “first,” “second,” or the like used in various embodiments of the present disclosure may modify various component elements in the various embodiments but may not limit corresponding component elements. For example, the above expressions do not limit the sequence and/or importance of the corresponding elements. The expressions may be used to distinguish a component element from another component element. For example, a first user device and a second user device indicate different user devices although both of them are user devices. For example, a first constituent element may be termed a second constituent element, and likewise a second constituent element may also be termed a first constituent element without departing from the scope of various embodiments of the present disclosure.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

The terms as used in various embodiments of the present disclosure are merely for the purpose of describing particular embodiments and are not intended to limit the various embodiments of the present disclosure. As used herein, the singular forms are intended to include the plural forms as well, unless the context clearly indicates otherwise.

Unless defined otherwise, all terms used herein, including technical terms and scientific terms, have the same meaning as commonly understood by a person of ordinary skill in the art to which various embodiments of the present disclosure pertain. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to embodiments of the present disclosure may be a device including a communication function. For example, the electronic devices may include at least one of smart phones, tablet personal computers (PCs), mobile phones, video phones, e-book readers, desktop PCs, laptop PCs, netbook computers, personal digital assistants (PDAs), portable multimedia players (PMPs), MP3 players, mobile medical devices, cameras, wearable devices (e.g., head-mounted-devices (HMDs) such as electronic glasses), electronic clothes, electronic bracelets, electronic necklaces, electronic appcessories, electronic tattoos, or smart watches.

According to some embodiments, the electronic device may be a smart home appliance with a communication function. The smart home appliances may include at least one of, for example, televisions, digital video disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to some embodiments, the electronic device may include at least one of a part of furniture or a building/structure having a communication function, an electronic board, an electronic signature receiving device, a projector, and various kinds of measuring instruments (e.g., a water meter, an electric meter, a gas meter, a radio wave meter, and the like). The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

A wireless charging apparatus according to various embodiments of the present disclosure may include an electronic device and a charging pad that is capable of executing contactless charging. An electronic device that is placed on the charging pad may be a smart phone, a portable phone, a navigation device, a game console, Television, a head unit for vehicles, a notebook computer, a laptop computer, a tablet computer, a Personal Media Player (PMP), a Personal Digital Assistants (PDA), and the like, or may be embodied as a pocket-size portable communication terminal including a wireless communication function. Further, the electronic device may be a flexible device or a flexible display device. A solar cell module may be provided in the electronic device, which converts a light source emitted from the charging pad into power, corresponding to a charging pad. In addition, the wireless charging apparatus may be configured to execute a charging operation in only an area where an electronic device is sensed.

A wireless charging apparatus according to various embodiments of the present disclosure may include a wireless power transmitter that is included in a charging pad where an electronic device is placed, and includes a light source unit that provides light to a solar cell module included in the electronic device, wherein the light source unit includes a plurality of light sources that emit light outside the charging pad; and a plurality of sensors that are disposed between the light sources and close to the light sources, and sense the electronic device.

According to one of the various embodiments of the present disclosure, the wireless charging apparatus may further include a controller that controls an ON/OFF state of the light sources based on sensing of the sensors.

According to one of the various embodiments of the present disclosure, wherein, when the electronic device is placed on the charging pad, the sensors in a contact area of the electronic device sense contact of the electronic device, and the controller controls light sources located toward the inside from the sensors disposed on an end part of the contact area.

According to one of the various embodiments of the present disclosure, the charging pad includes a first area where the electronic device is placed, and a second area where the electronic device is not placed.

According to one of the various embodiments of the present disclosure, the first area includes first sensors that sense contact of the electronic device from among the sensors, the second area includes second sensors from among the sensors, and the first sensors include boundary sensors that are disposed in the outermost area of the first area.

According to one of the various embodiments of the present disclosure, the light sources includes first light sources that are disposed in the first area, and includes a first location light source disposed toward the inside from the boundary sensors and a second location light source disposed toward the outside from the boundary sensors, and second light sources that are disposed in the second area, wherein the controller turns the first location light source on.

According to another embodiment of the various embodiments of the present disclosure, a wireless charging apparatus includes a wireless power receiver including a solar cell module provided in an electronic device, a wireless power transmitter included in a charging pad where the electronic device is placed, and that includes sensors that sense contact with the electronic device, and a plurality of light sources that provide light to the solar cell module based on whether the sensors sense contact, and a controller that controls light emission of the light sources, based on whether the sensors sense contact, wherein the controller controls light sources to emit light, which are located towards the inside from the outermost sensors from among the sensors that sense the contact of the electronic device, and the emitted light is converted into electric power through the solar cell module and contactless charging is executed.

According to one of the various embodiments of the present disclosure, the wireless charging apparatus is divided into a first area that is in contact with the electronic device and a second area that is not in contact with the electronic device.

According to one of the various embodiments of the present disclosure, the first area includes an emission area that is located towards the inside from the boundary sensors that are disposed in the outermost area among the sensors that sense the contact of the electronic device, and a non emission area that is located between the outside of the boundary sensors and an outline of the first area.

According to one of the various embodiments of the present disclosure, the light sources include first light sources including a first location light source disposed in the emission area and a second location light source disposed in the non emission area, and second light sources that are disposed in the second area.

According to one of the various embodiments of the present disclosure, the controller executes a control to turn the first light sources on.

According to one of the various embodiments of the present disclosure, the wireless charging apparatus further includes a heat dissipation plate disposed on a surface of the charging pad, so as to emit light of the light sources and radiate heat generated from the light.

The heat dissipation plate includes a plurality of openings that correspond to locations of the light sources so as to pass light emitted from the light sources.

According to one of the various embodiments of the present disclosure, the heat dissipation plate includes first openings that correspond to the locations of the light sources and pass through the top and bottom of the heat dissipation plate and second openings that correspond to the locations of the sensors and pass through the top and the bottom of the heat dissipation plate.

According to various embodiments of the present disclosure, the heat dissipation plate is formed so as to include a metallic material.

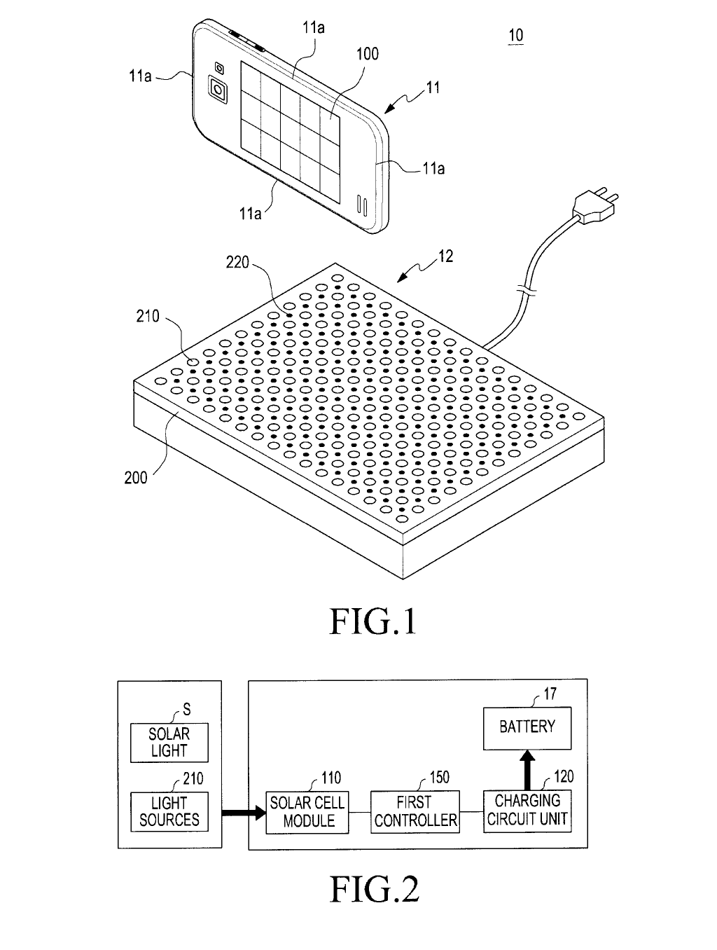

Hereinafter, a wireless charging apparatus according to various embodiments will be described with reference to FIGS. 1 to 9. The term “user” used in various embodiments of the present disclosure may indicate a user who uses an electronic device or a device that uses an electronic device, such as an artificial intelligence electronic device.

FIG. 1 is a diagram illustrating a wireless charging apparatus according to one of the various embodiments of the present disclosure. FIG. 2 is a block diagram illustrating an operation of a wireless power receiver 100 in a wireless charging apparatus according to one of the various embodiments of the present disclosure.

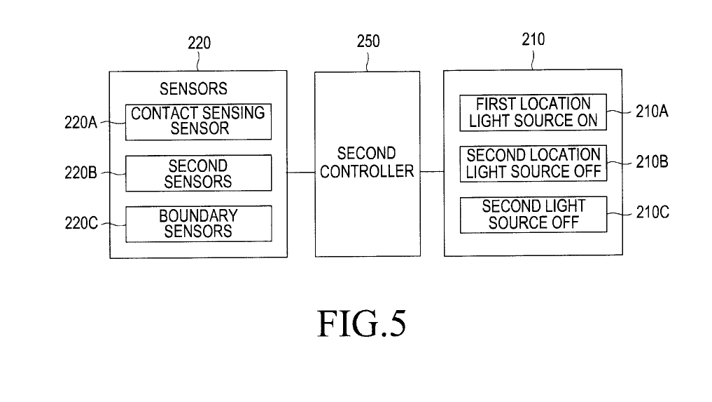

Referring to FIGS. 1 and 2, a wireless charging apparatus 10 according to various embodiments of the present disclosure may include the wireless power receiver 100 included in an electronic device 11 and a wireless power transmitter 200 included in a charging pad 12 where the electronic device 11 is placed, and may include a controller 150 (or a controller 250, please refer to FIGS. 2 and 5) that controls the wireless power receiver 100 and the wireless power transmitter 200.

In particular, the wireless power receiver 100 may be provided in the electronic device 11. The wireless power receiver 100 according to an embodiment of the present disclosure may include a solar cell module 110 that is mounted on the back side of the electronic device 11, and a charging circuit unit 120 (not illustrated).

The solar cell module 110 (FIG. 2) may be mounted on the electronic device 11, and more particularly, on the surface of the electronic device 11, and may receive solar light or light of a predetermined wavelength emitted from the charging pad 12, and may convert the light energy into electrical energy.

The charging circuit unit 120 may be included in the electronic device 11, and may be electrically connected to the solar cell module 110, and the charging circuit unit 120 may charge a battery mounted on the electronic device 11 with electrical energy input by the solar cell module 110.

The solar cell module 110 may be formed of a plurality of solar cells, which may be configured to receive light emitted from light sources 210 to convert light energy into electrical energy and to output electrical energy.

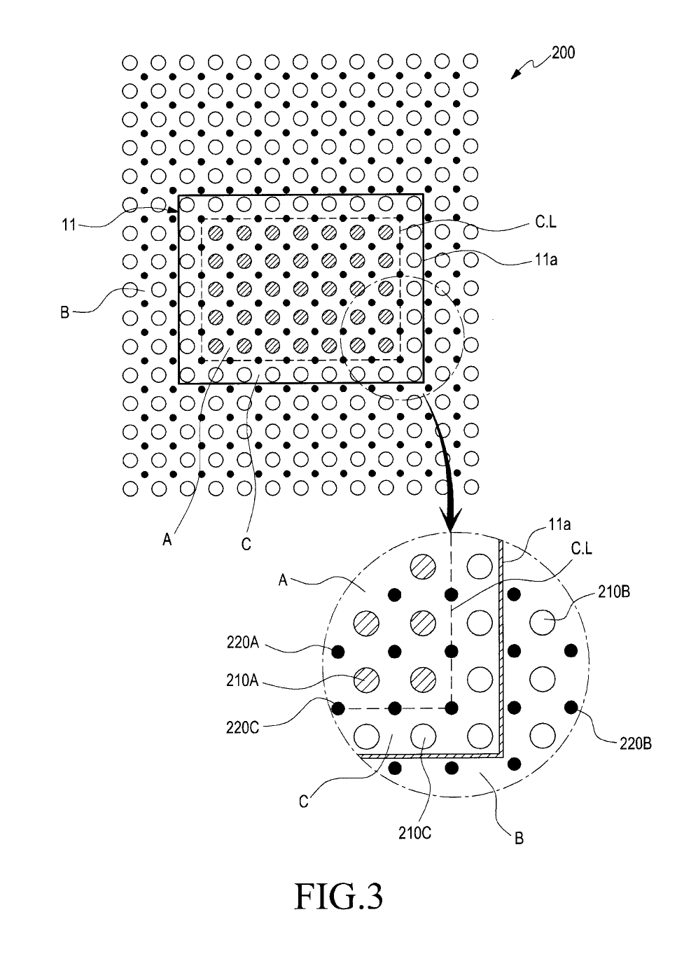

The electronic device 11 may include a controller (hereinafter referred to as a ‘first controller 150’, please refer to FIG. 3) that may execute a control to charge the battery with the electrical energy converted in the solar cell module 110. In particular, the solar cell module 110 that receives solar light S or light emitted from the light sources 210, converts light energy into electrical energy, and the first controller 150 may control the charging circuit unit 120 to charge the battery with electrical energy converted in the solar cell module 110.

Although it is illustrated that the solar cell module 110 according to an embodiment of the present disclosure is provided on the back of the electronic device 11, this may not be limited thereto. For example, any modification or change can be made when the solar cell module 110 is provided on the surface of the electronic device 11 and is located in a place that allows the solar cell module 110 to receive solar light S or light of a predetermined wavelength. For example, the solar cell module 110 may be included on the front side, or may be located on both of the front surface and the back surface of the electronic device 11. When the solar cell module 110 is provided on both of the front and the back of the electronic device 11, and the back of the electronic device 11 meets the charging pad 12, the solar cell module 110 provided on the front surface of the electronic device 11 may receive solar light S and execute power conversion for outputting, and the solar cell module 110 provided on the back surface of the electronic device 11 may receive light emitted from a light source of the charging pad 12 while being placed on the charging pad 12, and execute power conversion for outputting.

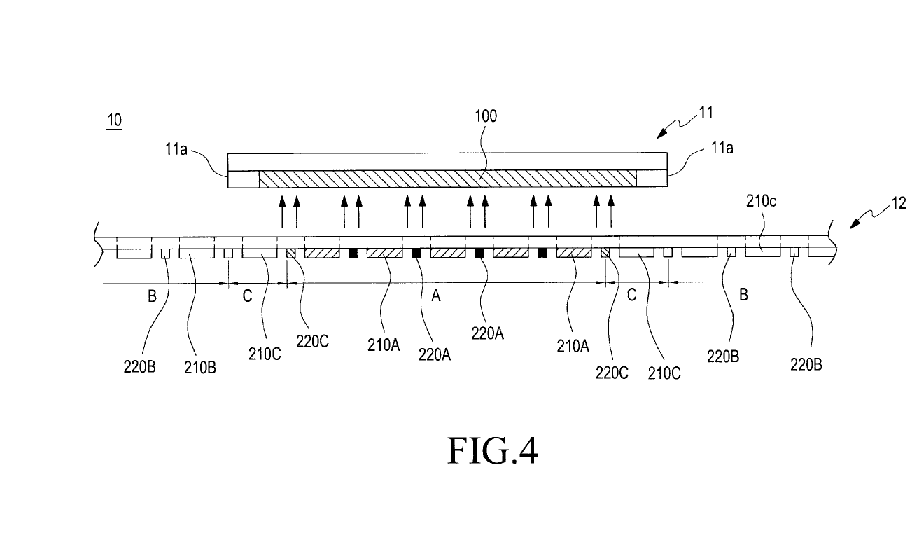

FIG. 3 is a schematic plan view of an electronic device placed on a charging pad, in a wireless charging apparatus according to one of the various embodiments of the present disclosure. FIG. 4 is a sectional view of an electronic device placed on a charging pad, in a wireless charging apparatus according to one of the various embodiments of the present disclosure.

Referring to FIGS. 3 and 4, the wireless power transmitter 200 may be included in the charging pad 12, and the wireless power transmitter 200 may provide light to the solar cell module 110 and may include light source units 210 and 220 to sense the electronic device 11 that is placed on the charging pad 12. The charging pad 12, particularly, the light source units 210 and 220, may be divided into an area where the electronic device 11 is placed and an area where the electronic device 11 is not placed, as the electronic device 11 is placed on the charging pad 12.

First, the light source units 210 and 220 according to various embodiments of the present disclosure may include a plurality of light sources 210 and sensors 220.

The light sources 210 are disposed towards the inner portion of the charging pad 12 to be close to one another at regular intervals, and are configured to emit light in the upward direction. The light sources 210 are configured to radiate light of a predetermined wavelength that may flow into the solar cell module 110 for power conversion. The light sources 210 according to one of the various embodiments of the present disclosure may include first light sources 210A and 210C located in a first area A and C (an area where the electronic device 11 is in contact with the charging pad 12, including an emission area A and non-emission area C), and second light sources 210B located in a second area B (an area where the electronic device 11 is not in contact with the charging pad 12), based on the divided areas of the charging pad 12. In addition, the first light sources 210A and 210C may include a first location light source 210A located in the emission area A and a second location light source 210C located in the non-emission area C. When the electronic device 11 is placed on the charging pad 12, only the first location light source 210A emits light based on a control of the second controller 250.

The sensors 220 are disposed to be adjacent to the light sources 210, and are configured to sense the electronic device 11 that is placed on the charging pad 12.

The sensors may be classified as sensors 220A and 220C (hereinafter referred to as ‘first sensors 220A and 220C’) that are located in a contact area of the electronic device 11 and sensors 220B (hereinafter referred to as ‘second sensors 220B’) that are located in a non-contact area. In addition, the first sensors 220A and 220C may include boundary sensors 220C, which are located in the outermost area among the first sensors 220A and 220C so that they are disposed to be adjacent to the outline of the electronic device 11, and contact sensing sensors 220A, which are disposed towards the inside from the boundary sensors 220C. Both the boundary sensors 220C and the contact sensing sensors 220A may be capable of sensing the contact of the electronic device 11, however, the outside and the inside distinguished based on the boundary sensors 220C may be divided into the emission area A and the non emission area B and C (non emission area C and the second area B).

FIG. 5 is a block diagram illustrating an operation of a wireless power transmitter in a wireless charging apparatus according to one of the various embodiments of the present disclosure.

Referring to FIG. 5, a second controller 250 may control light sources 210 located in the emission area A, particularly an ON/OFF state of the first location light sources 210A, based on sense values sensed by the sensors 220, particularly, the boundary sensors 220C and the contact sensing sensors 220A. Accordingly, when the electronic device 11 is placed on the charging pad 12, the boundary sensors 220C and the contact sensing sensors 220A located in the first area A and C that faces the first electronic device 11 may sense the contact of the electronic device 11. Sense values obtained by the boundary sensors 220 and the contact sensing sensors 220A may be provided to the second controller 250. The second controller 250 may control the first location light sources 210A of the emission area A to emit light based on the provided value.

Referring again to FIGS. 3 and 4, as described above, the wireless power transmitter 200 may be divided into a contact area and a non contact area based on whether sensors 220 sense contact, and particularly, the wireless power transmitter 200 may be divided into three areas. The divided areas of the charging pad 12 according to various embodiments of the present disclosure may vary based on a location where the electronic device 11 is placed.

In particular, the charging pad 12, that is, the wireless power transmitter 200, may be divided onto a first area A and C (an area inside a solid line of FIG. 3, and an area corresponding to C on the left, A, and C on the right of FIG. 4) that is in contact with the electronic device 11, and a second area B (an area outside the solid line of FIG. 3, and an area corresponding to B on the left and B on the right of FIG. 4) that is not in contact with the electronic device 11. The first area A and C may be divided into an emission area A (an area inside a broken line of FIG. 3, and an area corresponding to A of FIG. 4) and a non-emission area C (an area between the broken line and the solid line of FIG. 3, and an area corresponding to C of FIG. 4). Therefore, the charging pad 12 may be divided into the emission area A, the non-emission area C, and the second area B.

In particular, the first area A and C refers to an area that is in contact with the electronic device 11 in the charging pad 12, and the second area B is the remaining area after excluding the first area A and C, which refers to an area that is not in contact with the electronic device 11.

The first area A and C may include boundary sensors 220C and the contact sensing sensors 220A among the sensors 220, and the first light sources 210A and 210C from among the light sources 210 (the first light sources 210A and 210C include the first location light source 210A and the second location light source 210C). In addition, the first area A and C may include the emission area A that is inside a virtual closed loop curve (corresponding to the broken line) obtained by connecting the boundary sensors 220C and the non emission area B that is outside the closed loop curve of the boundary sensors 220C, based on the boundary sensors 220C.

The emission area A may include the first location light source 210A and the contact sensing sensors 220A, and the non emission area C may include the second location light source 210C and the boundary sensors 220C.

The second area B may include the second sensors 220B and the second light sources 210B.

In the wireless charging apparatus 10 configured as described above, when the electronic device 11 is placed on the charging pad 12, the wireless power transmitter 200 may be divided into the first area A and C that is in contact with the electronic device 11 and the second area B corresponding to the non contact area. In addition, based on the boundary sensors 220C, the emission area A that emits light and the non emission area unit B and C that does not emit light may be divided.

Therefore, the wireless charging apparatus 10 according to an embodiment of the present disclosure may be configured to enable only the first location light source 210A to emit light, which is located in the emission area A located toward the inside from the boundary sensors 220C from among the first light sources 210A and 210C, instead of controlling all the first light sources 210A and 210C in the first area A and C to emit light, when the electronic device 11 is placed on a heat dissipation plate 270 of the charging pad 12.

The wireless power transmitter 200 according to one of the various embodiments of the present disclosure may be provided in a standby state when the electronic device 11 is not placed, so that it is always available for contactless charging.

When the electronic device 11 is placed on the charging pad 12 equipped with the wireless power transmitter 200, the first sensors 220A and 220C of the first area A and C may sense the contact of the electronic device 11.

Sense values of the first sensors 220A and 220C, particularly, the contact sensing sensors 220A and the boundary sensors 220C, may be provided to the second controller 250, and the second controller 250 may execute a control so as to turn on the first location light source 210A of the emission area A, based on the sense values provided to the second controller 250 from the contact sensing sensors 220A and the boundary sensors 220C. Accordingly, the first location light source 210A of the emission area A out of the entire area of the wireless power transmitter 200 is turned on and light emitted from the first location light source 210A may be provided to the solar cell module 110 on the back of the electronic device 11. The solar cell module 110 receives light emitted from the first location light source 210A, and converts light energy to electrical energy, and the first controller 150 may execute a control so as to transfer the converted electrical energy to the charging circuit unit 120 and to charge a battery.

As described in one of the various embodiments of the present disclosure, only the light sources 210 of the emission area A among the area facing the electronic device 11 may emit light and thus, the dispersion of light to the outside of the electronic device 11 may be limited. In addition, it may be that only the light sources 210 of the emission area A out of the area facing the electronic device 11 emit light, thereby minimizing power consumption.

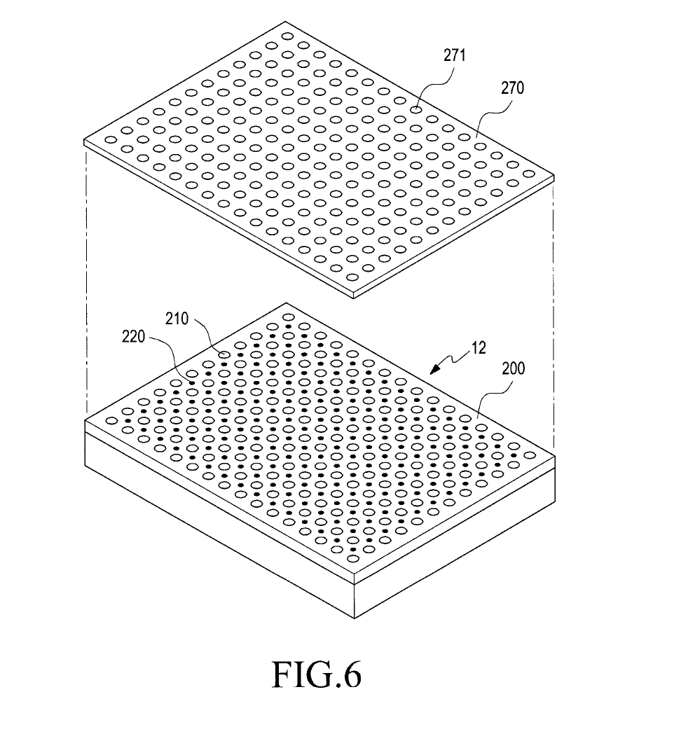

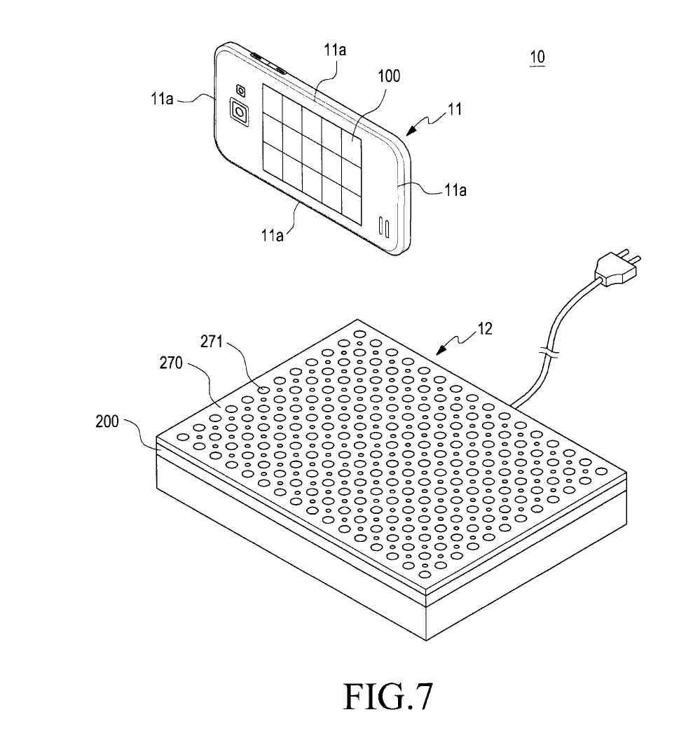

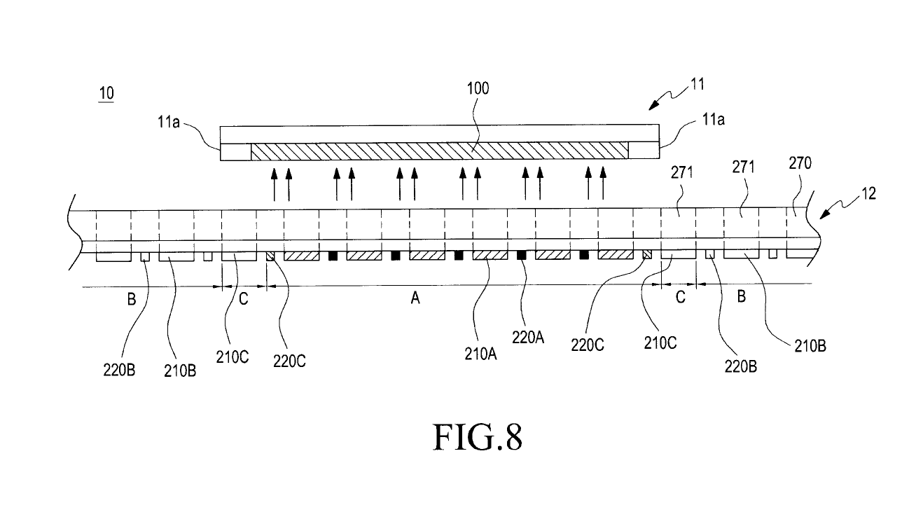

FIG. 6 is a diagram illustrating a heat dissipation plate layered on a wireless power transmitter, in a wireless charging apparatus according to one of the various embodiments of the present disclosure. FIG. 7 is a diagram illustrating an electronic device and a charging pad equipped with a heat dissipation plate, in a wireless charging apparatus according to one of the various embodiments of the present disclosure. FIG. 8 is a sectional view of an electronic device placed on a charging pad, in a wireless charging apparatus according to one of the various embodiments of the present disclosure.

The wireless charging apparatus 10 according to one of the various embodiments of the present disclosure may have an identical configuration to the wireless charging apparatus 10 according to an embodiment described with reference to FIGS. 1 to 5, but is distinguished in that the heat dissipation plate 270 is included in the charging pad 12 so as to radiate heat generated from the light sources 210. Therefore, when an embodiment of the present disclosure is described, the identical configuration of the wireless charging apparatus 10 is applied correspondingly and a configuration having a difference will be described in detail.

Referring to FIGS. 6 to 8, the heat dissipation plate 270 may be included on the surface of the charging pad 12 according to an embodiment of the present disclosure, so as to radiate heat generated from the light sources 210. In the heat dissipation plate, an opening 271 may be formed, through which light emitted from the light sources 210 of the charging pad 12 passes and is provided to the solar cell module 110 of the electronic device 11 that is placed on the heat dissipation plate 270. The openings 271 may be included to correspond to locations of the light sources 210.

The heat dissipation plate 270 may be formed, including a metallic material so as to receive heat generated from the light sources 210 and to radiate the heat to the outside. However, the heat dissipation plate may not be limited thereto. For example, any modification and change may be applicable when the sensors 220 are capable of sensing the electronic device 11 that is placed on the heat dissipation plate 270 and a material forming the heat dissipation plate 270 is capable of receiving light generated from the light sources 210 and radiating the heat to the outside.

In the wireless charging apparatus 10 configured as described above, when the electronic device 11 is placed on the charging pad 12, the wireless power transmitter 200 may be divided into the first area A and C that is in contact with the electronic device 11 and the second area B corresponding to the non contact area. In addition, based on the boundary sensors 220C, the emission area A that emits light and the non-emission area B and C that does not emit light may be divided.

Therefore, the wireless charging apparatus 10 according to an embodiment of the present disclosure may be configured to enable only the first location light source 210A to emit light, which is located in the emission area A disposed toward the inside from the boundary sensors 220C from among the first light sources 210A and 210C, instead of controlling all the first light sources 210A and 210C in the first area A and C to emit light, when the electronic device 11 is placed on the heat dissipation plate 270 of the charging pad 12.

The wireless power transmitter 200 according to one of the various embodiments of the present disclosure may be provided in a standby state when the electronic device 11 is not placed, so that it is always available for contactless charging.

When the electronic device 11 is placed on the charging pad 12 equipped with the wireless power transmitter 200, the first sensors 220A and 220C of the first area A and C may sense the contact of the electronic device 11.

Sense values of the first sensors 220A and 220C, particularly, the contact sensing sensors 220A and the boundary sensors 220C, may be provided to the second controller 250, and the second controller 250 may execute a control so as to turn on the first location light source 210A of the emission area A, based on the sense values provided to the second controller 250 from the contact sensing sensors 220A and the boundary sensors 220C. Accordingly, the first location light source 210A of the emission area A out of the entire area of the wireless power transmitter 200 is turned on and light emitted from the first location light source 210A may pass through the opening 271 and may be provided to the solar cell module 110 on the back of the electronic device 11. The solar cell module 110 may receive light emitted from the first location light source 210A, and converts light energy into electrical energy, and the first controller 150 may execute a control so as to transfer the converted electrical energy to the charging circuit unit 120 and to charge a battery.

In addition, heat that is generated as light is emitted from the first location light source 210A may be transferred to the heat dissipation plate, so that the heat is transferred to the entirety of the heat dissipation plate and may be radiated to the outside.

As described in one of the various embodiments of the present disclosure, only the light sources 210 of the emission area A out of the area facing the electronic device 11 may emit light and thus, the dispersion of light to the outside of the electronic device 11 may be limited. In addition, only the light sources 210 of the emission area A out of the area facing the electronic device 11 may emit light and thus, power consumption may be minimized.

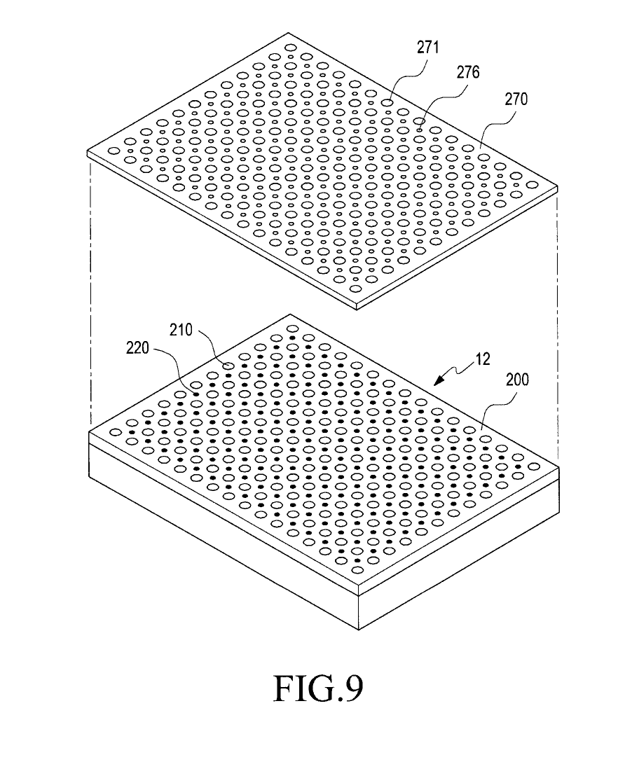

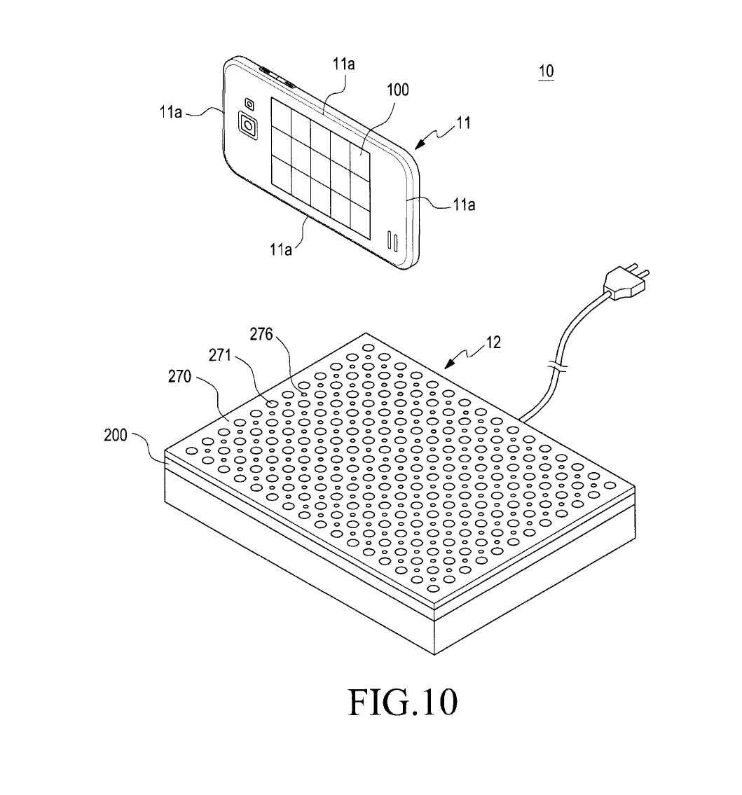

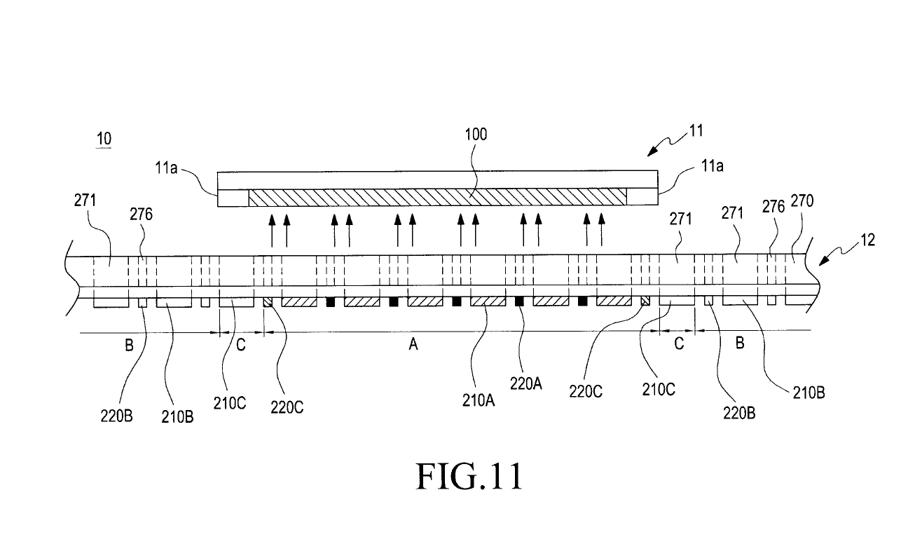

Hereinafter, with reference to FIGS. 9 to 11, another embodiment of a heat dissipation plate, which may be layered on a wireless power transmitter, will be described. FIG. 9 is a perspective view of another embodiment of the present disclosure in which a heat dissipation plate is shown relative to a wireless power transmitter. FIG. 10 is a perspective view of the electronic device shown relative to the charging pad equipped the heat dissipation plate of a wireless charging apparatus of FIG. 9 according to one of the various embodiments of the present disclosure. FIG. 11 is a sectional view of the electronic device placed on another example of a charging pad in a wireless charging apparatus of FIG. 9 according to one of the various embodiments of the present disclosure.

In another embodiment, a wireless charging apparatus may be substantially similar to the other embodiments described herein except as described hereinbelow, particularly in regard to the configuration of a heat dissipation plate. Accordingly, the above descriptions will be applied correspondingly to the duplicate or identical configuration, and a configuration having a difference will be described in detail.

Referring to FIGS. 9 to 11, the heat dissipation plate 270 may be included on the surface of the charging pad 12 according to an embodiment of the present disclosure, so as to radiate heat generated from the light sources 210. The heat dissipation plate 270 may include a plurality of first openings 271 and a plurality of second openings 276, which are adjacent to the first openings 271.

The first openings 271 may be disposed to correspond to locations of the light sources 210 of the charging pad 12, and may be formed to pass through the top and the bottom of the heat dissipation plate 270. The first openings 271 may be formed, through which light emitted from the light sources 210 of the charging pad 12 passes and is provided to the solar cell module 110 of the electronic device 11 that is placed on the heat dissipation plate 270.

The second openings 276 may be disposed to correspond to locations of the sensors 220 of the charging pad 12, and may be formed to pass through the top and the bottom of the heat dissipation plate 270. This may limit the interference of the heat dissipation plate to the sensors 220.

The wireless charging apparatus according to an embodiment of the present disclosure may also execute identical operations to the wireless charging apparatus according to the above-described embodiment. However, the sensors 220 may be connected to the outside through the second openings, unlike the above-described embodiment. Therefore, the sensors 220A and 220C located in the first area A and C, which is an area that is in contact with the electronic device 11, may sense proximity or contact of the electronic device 11 through the second openings 276. In addition, the sensors 220B of the second area B that is contactless area, may be configured to be exposed to the outside through the second openings.

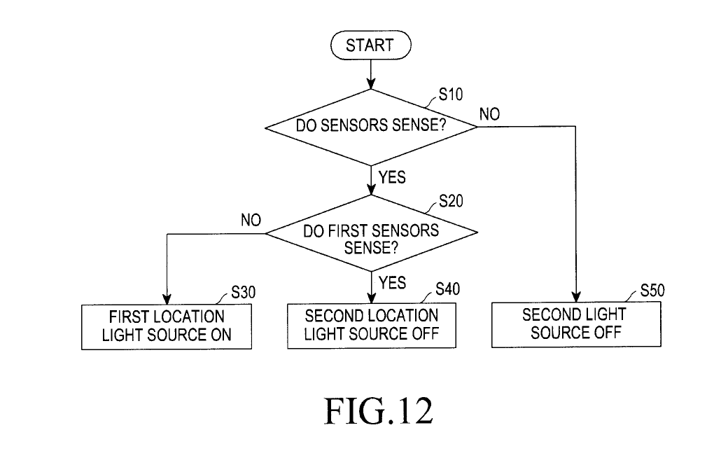

FIG. 12 is a flowchart illustrating an operation of a wireless charging apparatus according to one of the various embodiments of the present disclosure.

Referring to FIG. 12 in the wireless charging apparatus 10 having the above described configuration, the wireless power transmitter 200 of the charging pad 12 may be provided in a standby state, so that contactless charging may be executed irrespective of time. In this instance, when the electronic device 11 is placed on the charging pad 12, the wireless power transmitter 200 may begin contactless charging, in correspondence to the wireless power receiver 100.

In particular, the sensors 220 of the wireless power transmitter 200 may detect a signal based on whether the electronic device 11 is in contact, in operation S10.

When the electronic device 11 is placed on the wireless power transmitter 200, sensors (first sensors) corresponding to the location where the electronic device 11 is placed, may sense the proximity or contact of the electronic device 11, and when sensors that fail to sense the contact of the electronic device 11 among the sensors 220, the second light sources 210B located in the second area B may maintain the OFF-state in operation S50.

Conversely, when the sensors that sense the contact of the electronic device 11 among the sensors 220, particularly, the first sensors (boundary sensors 220C and the contact sensing sensors 220A) may be in contact or proximity with the electronic device. In particular, whether the first location light source 210A or the second location light source 210C, distinguished based on the outline of the electronic device 11, emits light may be determined based on sensing of the first sensors 220A and 220C, in operation S20. The second controller 250 may control emission of the first location light source and the second location light source, based on sensed values of the boundary sensors 220C and the contact sensing sensors 220. That is, the first location light source 210A on the emission area A may be turned on and emits light with respect to the wireless power receiver 100, in operation S30. In addition, the second location light source 210C on the non-emission area C may maintain the OFF-state in operation S40.

The above described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

Various embodiments of the present disclosure disclosed in this specification and the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of various embodiments of the present disclosure fall within the scope of the present disclosure.

What is claimed is:

1. A wireless charging apparatus comprising:
a charging pad;
a wireless power transmitter operatively coupled to the charging pad, which is configured to have an electronic device including a solar cell module placed thereon;
a light source unit being operatively coupled to the charging pad, the light source unit configured to provide light to the solar cell module,
wherein the light source unit comprises:
at least one light source that emits light outside the charging pad; and
at least one sensor configured to sense the electronic device.

2. The apparatus of claim 1, further comprising:
a controller that is configured to control the state of the at least one light source between an on and an off state based on information received by the sensor.

3. The apparatus of claim 2, wherein the electronic device includes sensors and a contact area, and wherein when the electronic device is placed on the charging pad, the sensors on the contact area of the electronic device sense contact of the electronic device, and
the controller controls light sources located toward the inside from the sensors disposed in an end part of the contact area.

4. The apparatus of claim 2, wherein the charging pad includes a first area where the electronic device is placed, and a second area where the electronic device is not placed, and
wherein the first area includes first sensors that sense contact of the electronic device from among the sensors, the second area including second sensors from among the sensors; and the first sensors including boundary sensors that are disposed in the outermost area of the first area.

5. The apparatus of claim 4, wherein the light sources comprise:
first light sources that are disposed in the first area, and include a first location light source disposed toward the inside from the boundary sensors and a second location light source disposed toward the outside from the boundary sensors; and
second light sources that are disposed in the second area,
wherein the controller turns the first location light source on.

6. The apparatus of claim 1, wherein the at least sensor includes a plurality of sensors, and wherein the at least one light source includes a plurality of light sources, the sensors being positioned between the light sources.

7. A wireless charging apparatus comprising:
a wireless power receiver including a solar cell module provided in an electronic device;
a wireless power transmitter included in a charging pad on which the electronic device is configured to be placed, the wireless power transmitter including sensors that sense contact of the electronic device, and a plurality of light sources that provide light to the solar cell module based on whether the sensors sense contact; and
a controller that controls light emission of the light sources based on whether the sensors sense contact,
wherein the controller controls light sources to emit light, the light sources located towards the inside from the outermost sensors from among the sensors that sense the contact of the electronic device, and wherein the emitted light is converted into electric power through the solar cell.

8. The apparatus of claim 7, wherein the apparatus is divided into a first area that is in contact with the electronic device and a second area that is not in contact with the electronic device, and wherein the the first area comprises:
an emission area that is located towards the inside from the boundary sensors that are disposed in the outermost area among the sensors that sense the contact of the electronic device; and
a non emission area that is located between the outside of the boundary sensors and an outline of the first area.

9. The apparatus of claim 8, wherein the light sources comprises:
first light sources including a first location light source disposed in the emission area and a second location light source disposed in the non emission area; and
second light sources that are disposed in the second area.

10. The apparatus of claim 9, wherein the controller executes a control to turn the first light sources on.

11. The apparatus of claim 8, further comprising:
a heat dissipation plate disposed on a surface of the charging pad, so as to emit light of the light sources and radiate heat generated from the light.

12. The apparatus of claim 11, wherein the heat dissipation plate includes a plurality of openings that correspond to locations of the light sources so as to pass light emitted from the light sources.

13. The apparatus of claim 11, wherein the heat dissipation plate includes first openings that correspond to the locations of the light sources and pass through the top and bottom of the heat dissipation plate and second openings that correspond to the locations of the sensors and pass through the top and the bottom of the heat dissipation plate.

14. The apparatus of claim 11, wherein the heat dissipation plate is formed to include a metallic material.
